(19) United States
(12) Patent Application Publication
(10) Pub. No.: US 2018/0032869 A1
(43) Pub. Date: Feb. 1, 2018

(54) MACHINE LEARNING METHOD, NON-TRANSITORY COMPUTER-READABLE STORAGE MEDIUM, AND INFORMATION PROCESSING APPARATUS

(71) Applicant: FUJITSU LIMITED, Kawasaki-shi (JP)

(72) Inventors: Tsuguchika TABARU, Machida (JP); Masafumi YAMAZAKI, Tachikawa (JP); Akihiko KASAGI, Kawasaki (JP)

(73) Assignee: FUJITSU LIMITED, Kawasaki-shi (JP)

(21) Appl. No.: 15/661,455

(22) Filed: Jul. 27, 2017

(30) Foreign Application Priority Data
Jul. 29, 2016 (JP) 2016-150617

(51) Int. Cl. G06N 3/08; G06N 3/063

(52) U.S. Cl. CPC G06N 3/08; G06N 3/063

(57) ABSTRACT

A machine learning method, using a neural network as a model, executed by a computer, the machine learning method including dividing a first batch data into a plurality of pieces of second batch data, the first batch data being a set of sample data to be input into the model in a machine learning, allocating the plurality of pieces of second batch data to a plurality of computers, the model having a specified layered structure and a specified parameter of the neural network being applied to the plurality of computers, making the plurality of computers to execute the machine learning based on the plurality of allocated second batch data, obtaining, from each of the plurality of computers, a plurality of correction amounts of the parameter derived by the executed machine learning, and correcting the model by modifying the specified parameter in accordance with the plurality of correction amounts.

### CROSS-REFERENCE TO RELATED APPLICATION

This application is based upon and claims the benefit of priority of the prior Japanese Patent Application No. 2016-150617, filed on Jul. 29, 2016, the entire contents of which are incorporated herein by reference.

### FIELD

The embodiments discussed herein are related to a machine learning method, a non-transitory computer-readable storage medium, and an information processing apparatus.

### BACKGROUND

As an example of machine learning, deep learning using a multilayered neural network as a model is known. As an example, a stochastic gradient descent method is used in learning algorithm of deep learning.

In a case where the stochastic gradient descent method is used, whenever a training sample labeled with a correct solution of a positive or negative example is entered into the model, online learning of a model which minimizes error between output of the model and a correct solution of a training sample is realized. That is, a weight is corrected for each training sample in accordance with a correction amount of weights obtained for each neuron of each layer sequentially from an output layer to an input layer by using an error gradient.

In addition, the stochastic gradient descent method includes a case where weight correction is performed by collecting training samples on a unit basis called a mini-batch. As the size of the mini-batch is increased, the correction amount of the weight can be obtained with higher accuracy. As a result, it is possible to increase the learning speed of the model.

As examples of the related art, it is known that U.S. Patent Application Publication No. 20140180986 and Japanese Laid-open Patent Publication No. 2016-45943.

As examples of the related art, it is known that Ren Wu, Shengen Yan, Yi Shan, Qingqing Dang, and Gang Sun “Deep Image: Scaling up Image Recognition”, CoRR, Vol.abs/1501.02876, 2015, and Nitish Srivastava, Geoffrey Hinton, Alex Krizhevsky, Ilya Sutskever, and Ruslan Salakhutdinov “Dropout: A Simple Way to Prevent Neural Networks from Overfitting”, Journal of Machine Learning Research, Vol. 15, pp 1929-1958, 2014 are known.

### SUMMARY

According to an aspect of the invention, a machine learning method using a neural network as a model, the machine learning method being executed by a computer, the machine learning method including, dividing a first batch data into a plurality of pieces of second batch data, the first batch data being a set of sample data to be input into the model in a machine learning, the first batch data having a specified data size in which a parameter of the model is corrected, allocating the plurality of pieces of second batch data to a plurality of computers, the model having a specified layered structure and a specified parameter of the neural network being applied to the plurality of computers, making each of the plurality of computers to execute the machine learning based on each of the plurality of allocated second batch data, obtaining, from each of the plurality of computers, a plurality of correction amounts of the parameter derived by the executed machine learning, and correcting the model by modifying the specified parameter in accordance with the plurality of correction amounts.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a data processing system according to an embodiment 1;

FIG. 2 is a block diagram illustrating a functional configuration of each device included in the data processing system according to the embodiment 1;

FIG. 3 is a diagram illustrating an example of model learning;

FIG. 4 is a flowchart illustrating a procedure of a machine learning process according to the embodiment 1; and

FIG. 5 is a diagram illustrating a hardware configuration example of a computer executing a machine learning program according to the embodiment 1 and an embodiment 2.

### DESCRIPTION OF EMBODIMENTS

However, since mini-batch size is restricted by the capacity of memory connected to a processor in which learning is performed, there is a limit on the increase of batch size.

In one aspect, an advantage of the embodiment is to provide a machine learning method, a machine learning program, and an information processing apparatus capable of realizing an increase in a batch size where parameter correction in a model is performed.

Hereinafter, the machine learning method, the machine learning program, and the information processing apparatus according to the present application will be described with reference to the accompanying drawings. The embodiments do not limit a disclosed technology. It is possible to combine the embodiments appropriately in a range where they do not contradict processing contents.

### Embodiment 1

### System Configuration

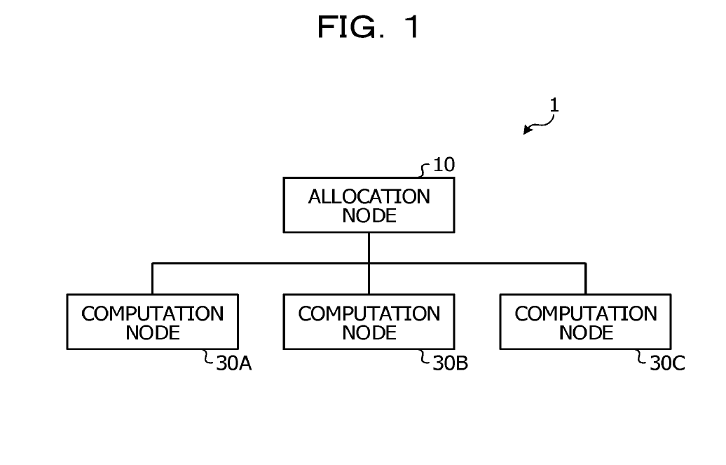

FIG. 1 is a diagram illustrating a configuration example of a data processing system according to an embodiment 1. As an example of model learning for image recognition and speech recognition, a data processing system 1 illustrated in FIG. 1 performs so-called deep learning using a multilayered neural network according to a stochastic gradient descent method.

In the data processing system 1 illustrated in FIG. 1, as a data set to be used for the model learning, a set of training samples to which a correction label of a positive example or a negative example is given is prepared. Moreover, the data processing system 1 collects a part of a data set on a unit basis called a “super-batch” and performs correction of parameters such as weights and biases of the model.

Here, an allocation node 10 distributes learning relating to a plurality of mini-batches into which the super-batch is divided, to a plurality of computation nodes 30A to 30C, and performs parallel processing on the distributed learning. In the following, there is a case where the computation nodes 30A to 30C illustrated in FIG. 1 are collectively referred to as the “computation node 30”. Here, a case where the number of the computation nodes 30 is three is exemplified. However, the number of computation nodes 30 may be two or more. For example, the computation node 30 of an arbitrary number of computations such as a number corresponding to the power of two of the computation node 30 can be accommodated in the data processing system 1.

As a result, it is possible to reduce the size of the super-batch, which is a unit for performing parameter correction, restricted by hardware for performing data processing related to learning, in this example, a memory capacity of the computation node 30. The reason is that even if the size of the super-batch exceeds the memory capacity of the computation node 30, the size of the mini-batch in which each of the computation nodes 30 is in charge of data processing can be matched with the memory capacity of each of the computation nodes 30 by a distribution process.

According to the allocation node 10 of the embodiment, it is possible to realize an increase of the batch size in which the parameter correction of the model is performed.

The data processing system 1 illustrated in FIG. 1 is constructed as a cluster including the allocation node 10 and the computation nodes 30A to 30C. Here, a case where the data processing system 1 is constructed as a GPU cluster by a general-purpose computing on graphics processing unit (GPGPU) or the like is exemplified. The allocation node 10 and the computation nodes 30A to 30C are connected to each other through an interconnect such as InfiniBand. The GPU cluster is merely an example of implementation, and may be constructed as a computer cluster by a general-purpose central processing unit (CPU) regardless of the type of processor as long as distributed parallel processing can be realized.

Among them, the allocation node 10 is a node for allocating the learning of the mini-batch into which the super-batch is divided for the computation node 30. The computation node 30 is a node for performing data processing relating to the learning of the mini-batch allocated on the allocation node 10. Each node of these allocation node 10 and computation nodes 30A to 30C can have the same performance or different performances.

Hereinafter, for the convenience of explanation, a case where the data processing on each of the computation nodes 30 is performed whenever the learning of the mini-batch is allocated for each of the computation nodes 30 is exemplified. However, the order in which the processing is performed is not limited thereto. For example, after the allocation node 10 sets allocation of the mini-batch for each of the computation nodes 30 for each super-batch, the computation nodes 30 may collectively perform data processing relating to the learning of the mini-batch. In this case, a node included in the GPU cluster may not perform the allocation of the mini-batch at any time, and it is possible to perform the allocation of the mini-batch for an arbitrary computer. In addition, the learning of the mini-batch is allocated for the allocation node 10 and thereby the allocation node 10 can also function as one of the computation nodes 30.

Configuration of Allocation Node 10

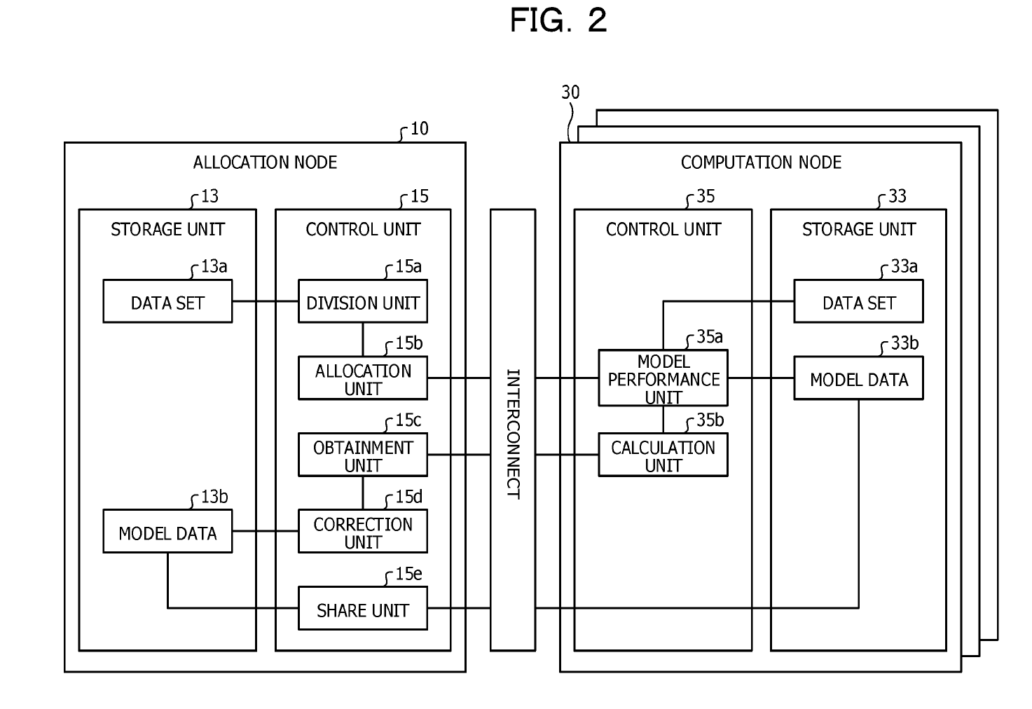

FIG. 2 is a block diagram illustrating a functional configuration of each apparatus included in the data processing system 1 according to the embodiment 1. As illustrated in FIG. 2, the allocation node 10 includes a storage unit 13 and a control unit 15. In FIG. 2, a solid line illustrating a relationship between input and output of data is illustrated, but only a minimum portion is illustrated for the convenience of explanation. That is, the input and output of data relating to each processing unit is not limited to the illustrated example, and input and output of data not illustrated, for example, input and output of data between a processing unit and a processing unit, between a processing unit and data, and between a processing unit and an external device may be performed.

The storage unit 13 is a device for storing various programs including an application such as an operating system (OS) executed in the control unit 15 and a machine learning program for realizing the allocation of the learning for the mini-batch, and further, data used for these programs.

As an embodiment, the storage unit 13 can be mounted on the allocation node 10 as an auxiliary storage device. For example, a hard disk drive (HDD), an optical disk, a solid state drive (SSD), or the like can be adopted in the storage unit 13. The storage unit 13 may not be mounted as the auxiliary storage device at any time, and can also be mounted as a main storage device on the allocation node 10. In this case, various types of semiconductor memory devices, for example, a random access memory (RAM) and a flash memory can be adopted in the storage unit 13.

As an example of the data used for the program executed in the control unit 15, the storage unit 13 stores a data set 13a and model data 13b. In addition to the data set 13a and the model data 13b, other electronic data, for example, weights, an initial value of a learning rate, or the like can also be stored together.

The data set 13a is a set of training samples. For example, the data set 13a is divided into a plurality of super-batches. For example, it is possible to set the size of the super-batch based on learning efficiency to be a target according to an instruction input by a model designer, for example, the speed at which the model converges, or the like without incurring restrictions on the memory capacity of the computation node 30. According to the setting of the super-batch, the data set 13a is secured in a state where the super-batch included in the data set 13a, and further, the training sample included in each super-batch can be identified by identification information such as identification (ID).

The model data 13b is data relating to the model. For example, a layered structure such as neurons and synapses of each layer of an input layer, an intermediate layer, and an output layer forming the neural network, and parameters such as weights and biases of each layer are included in the model data 13b.

The control unit 15 includes an internal memory for storing various types of programs and control data, and performs various processes by using these.

As an embodiment, the control unit 15 is implemented as a processor. For example, the control unit 15 can be implemented by the GPGPU. The control unit 15 may not be implemented by the GPU, and may be implemented by the CPU or a micro processing unit (MPU), or may be implemented by combining the GPGPU and the CPU. In this manner, the control unit 15 may be implemented as a processor, and it does not matter whether the processor is of the general-purpose type or the specialized type. In addition, the control unit 15 can also be realized by a hardwired logic such as an application specific integrated circuit (ASIC) and a field programmable gate array (FPGA).

The control unit 15 virtually realizes the following processing unit by developing the machine learning program as a process on a work area of the RAM mounted as the main storage device (not illustrated). For example, as illustrated in FIG. 2, the control unit 15 includes a division unit 15a, an allocation unit 15b, an obtainment unit 15c, a correction unit 15d, and a share unit 15e.

The division unit 15a is a processing unit for dividing the super-batch into the plurality of the mini-batches.

As an embodiment, the division unit 15a activates a process in a case where a learning instruction is received from an external device (not illustrated), for example, a computer or the like used by a designer of the model or the like. For example, a list of the identification information of the computation node 30 or the like used in the learning is designated, in addition to designation of a model, a data set, or the like to be a target of learning according to the learning instruction. According to the designation, the division unit 15a sets an initial value such as a learning rate by adding the parameters, for example, the weights and biases to the model designated by the learning instruction among the model data 13b stored in the storage unit 13 and thereby performs an initialization process. Subsequently, the division unit 15a reads setting of the super-batch relating to the data set designated by the learning instruction in the data set 13a stored in the storage unit 13. Accordingly, the division unit 15a identifies the computation node 30 participating in the learning from the list designated by the learning instruction, and distributes an initial model to each of the computation nodes 30. According to this, the model having the same layered structure and parameters as those of the neural network is shared among the computation nodes 30.

After these processes, the division unit 15a selects one super-batch in the data set. Subsequently, the division unit 15a calculates the size of the mini-batch for which the learning is allocated in each of the computation nodes 30, according to the capacity of the memory connected to the GPGPU of the computation node 30 participating in the learning. For example, in a case where the GPGPU of the computation node 30 calculates the correction amount of the weight for the training sample in parallel by a plurality of threads, by comparing the data size of the training sample, a model, model output, and a weight correction amount corresponding to the number of threads activated by the GPGPU with a free space of the memory to which the GPGPU is connected. The size of the mini-batch that can be processed in parallel by the GPGPU is estimated for each of the computation nodes 30. Moreover, the division unit 15a is divided according to the size of the mini-batch estimated for each of the computation nodes 30. The size of the super-batch can also be set by calculating backward so that excess or deficiency in terms of size does not occur in a case where the super-batch is divided by the size of the estimated mini-batch, and the size of the super-batch can also be adjusted and changed at a time when the size of the super-batch is estimated for each of the computation nodes 30 in a case where a remainder occurs.

The allocation unit 15b is a processing unit for allocating the learning of the mini-batch for the computation node 30.

As an embodiment, the allocation unit 15b notifies the computation node 30 in charge of the learning of the mini-batch of the identification information of the training sample included in the mini-batch whenever the super-batch is divided by the division unit 15a. For the computation node 30 receiving the notification, the GPGPU of the computation node 30 can identify the training sample to be a calculation target of the correction amount of the parameters. According to this, the computation node 30 can input the training sample to the model for each thread activated by the GPGPU, and calculate a correction amount of the parameters such as a correction amount Δw of the weight and a correction amount ΔB of the biases for neurons in each layer in order from the output layer to the input layer by using the error gradient between an output of the model and a correct solution of the training sample. In this manner, after calculation of the correction amount of the parameters for each training sample, correction amounts of the parameters are summed up.

The obtainment unit 15c is a processing unit for obtaining the sum of the correction amounts of the parameters.

As an embodiment, the obtainment unit 15c obtains the summation of the correction amount of the parameters from the computation nodes 30 whenever the sum of the correction amounts of the parameters is calculated in the computation nodes 30. In this manner, the sum of the correction amount of the parameters is obtained for each of the computation nodes 30.

The correction unit 15d is a processing unit for performing the correction of the model.

As an embodiment, the correction unit 15d performs a predetermined statistical process on the sum of the correction amounts of the parameters obtained for each of the computation nodes 30 whenever the sum of the correction amounts of the parameters for each of the computation nodes 30 is obtained by the obtainment unit 15c. For example, the correction unit 15d can calculate an average value by averaging the sum of the correction amounts of the parameters, as an example of the statistical process. Here, a case where the sum of the correction amounts of the parameters is averaged is exemplified. However, the embodiment may obtain a maximum frequent value and a middle value. Thereafter, the correction unit 15d corrects the parameters of the model, that is, the weights and biases in accordance with the average value obtained by averaging the sum of the correction amounts of the parameters for the computation nodes 30.

The share unit 15e is a processing unit for sharing the model after the correction.

As an embodiment, the share unit 15e delivers the model after the correction to each of the computation nodes 30 whenever the parameters of the model are corrected by the correction unit 15d. According to this, the model after the correction is shared between respective computation nodes 30.

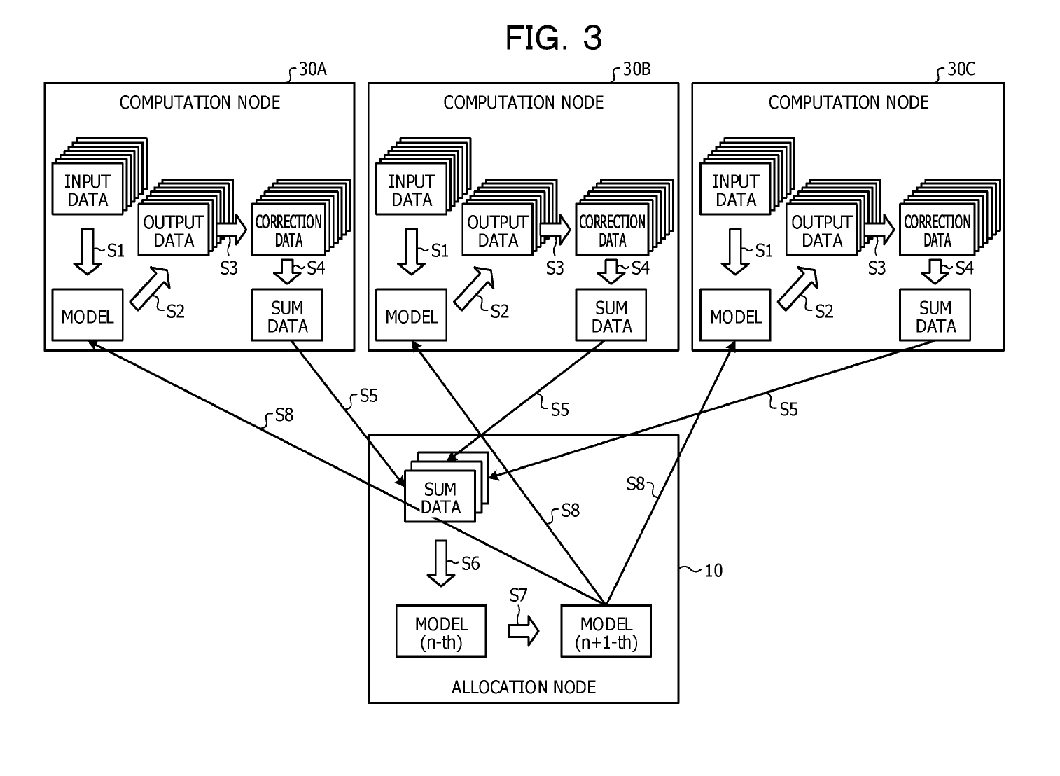

FIG. 3 is a diagram illustrating an example of the model learning. Input data illustrated in FIG. 3 corresponds to the training sample, output data corresponds to the output of the model, and correction data corresponds to the correction amounts of the parameters including the correction amount Δw of the weight and the correction amount ΔB of the biases. A case where the mini-batch, into which an n-th super-batch is divided as n-th model learning, is input to the computation nodes 30A to 30C is illustrated in FIG. 3.

As illustrated in FIG. 3, in each of the computation nodes 30, one or more threads are activated in the GPGPU of the computation node 30. Here, as an example, the following explanation will be described by exemplifying a case where threads of the same number as the number of the training samples included in the mini-batch are activated. In each thread, the model is performed and the training sample is input to the input layer as the input data in the model (S1). As a result, the output data output from the output layer of the model is obtained for each thread (S2). The correction amount of the parameters such as the correction amount Δw of the weight and the correction amount ΔB of the biases is calculated as the correction data for each neuron of each layer from the output layer to the input layer by using the error gradient between the output of the model and the correct solution of the training sample (S3). Subsequently, the correction amount of the parameters calculated for each training sample of the mini-batch is summed up (S4).

In this manner, after the sum of the correction amounts of the parameters is calculated in the computation node 30, the sum of the correction amounts of the parameters by the allocation node 10 is obtained for each of the computation nodes 30 (S5). Accordingly, the sum of the correction amounts of the parameters obtained for each of the computation nodes 30 is averaged (S6). Subsequently, the parameters of the model, that is, the weights and biases are corrected in accordance with the average value obtained by averaging the sum of the correction amounts of the parameters between the computation nodes 30 (S7). According to the correction, the model using n+1-th learning is obtained. Moreover, by transmitting the model after the correction from the allocation node 10 to each of the computation nodes 30 (S8), the model after the correction is shared between the computation nodes 30.

Computation Node

Next, the functional configuration of the computation node 30 according to the embodiment will be described. As illustrated in FIG. 2, each of the computation nodes 30 includes a storage unit 33 and a control unit 35. In FIG. 2, a solid line indicating a relationship between the input and output of data is illustrated. For the convenience of explanation, only a minimum portion is illustrated. That is, the input and output of data relating to each processing unit is not limited to the illustrated example, and input and output of data (not illustrated), for example, input and output of data between a processing unit and a processing unit, between a processing unit and data, and between a processing unit and an external device may be performed.

The storage unit 33 is a device that stores various programs including an application such as an OS executed in the control unit 35 and a learning program for realizing the learning of the mini-batch, and, further, data used for these programs.

As an embodiment, the storage unit 33 may be implemented as an auxiliary storage device of the computation node 30. For example, an HDD, an optical disk, an SSD, or the like can be adopted in the storage unit 33. The storage unit 33 may not be implemented as an auxiliary storage device, and may be implemented as a main storage device of the computation node 30. In this case, any one of various types of semiconductor memory devices, for example, a RAM or a flash memory can be adopted in the storage unit 33.

As an example of the data used for the program executed in the control unit 35, the storage unit 33 stores a data set 33a and model data 33b. In addition to the data set 33a and the model data 33b, other electronic data can also be stored together.

The data set 33a is a set of training samples. For example, the data set 33a shares the same data set as the data set 13a included in the allocation node 10. Here, as an example, a case where the data set is shared in advance between the allocation node 10 and the computation node 30 from the viewpoint of reducing communication between both, is exemplified. However, whenever the allocation node 10 allocates the learning of the mini-batch for the computation node 30, the mini-batch may be transmitted to the computation node 30.

The model data 33b is data relating to the model. As an example, the model data 33b shares the same data as that of the allocation node 10 by reflecting the model after the correction as the model data 33b whenever the model is corrected by the allocation node 10.

The control unit 35 includes an internal memory for storing various types of programs and control data, and performs various processes by using these.

As an embodiment, the control unit 35 is implemented as a processor. For example, the control unit 35 can be implemented by the GPGPU. The control unit 35 may not be implemented by the GPU, and may be implemented by the CPU or the MPU, or may be implemented by combining the GPGPU and the CPU. In this manner, the control unit 35 may be implemented as a processor, and it does not matter whether the processor is of the general-purpose type or the specialized type. In addition, the control unit 35 can also be realized by hardwired logic such as ASIC and FPGA.

The control unit 35 virtually realizes the following processing unit by developing the learning program as a process in the work area of the RAM implemented as the main storage device (not illustrated). For example, as illustrated in FIG. 2, the control unit 35 includes a model performance unit 35a and a calculation unit 35b. In FIG. 2, for the convenience of explanation, one model performance unit 35a is exemplified. However, in a case where a plurality of threads are activated by the GPGPU, a plurality of model performance units 35a in a number equal to the number of the threads are provided in the control unit 35.

The model performance unit 35a is a processing unit for performing the model.

As an embodiment, whenever the learning of the mini-batch is allocated for the allocation node 10, the model performance units 35a are activated that is in a number equal to the number of threads activated by the GPGPU of the computation node 30, for example, the number of the training samples of the mini-batch. At this time, among the model performance units 35a, the latest model which is a model having the same layered structure and the same parameters shared between the model performance units 35a, and corrected by the allocation node 10, is performed. The learning of the training sample included in the mini-batch for which the learning is allocated by the allocation node 10 is performed in parallel, for each model performance unit 35a activated in this manner. That is, in accordance with the identification information of the training sample notified from the allocation node 10, the training sample of the mini-batch is input to the input layer of the model performed by the model performance unit 35a. As a result, an output from the output layer of the model, so-called estimated data is obtained. Subsequently, the model performance unit 35a calculates the correction amount of the parameters such as the correction amount Δw of the weight and the correction amount ΔB of the biases for each neuron in each layer in order from the output layer to the input layer, by using the error gradient between the output of the model and the correct solution of the training sample. As a result, the correction amount of the parameters is obtained for each training sample included in the mini-batch.

The calculation unit 35b is a processing unit for calculating the sum of the correction amounts of the parameters.

As an embodiment, the calculation unit 35b sums the correction amount of the parameters whenever the correction amount of the parameters is calculated for the training sample of the mini-batch by the model performance unit 35a. Moreover, the calculation unit 35b transmits the sum of the correction amounts of the parameters to the allocation node 10.

Flow of Process

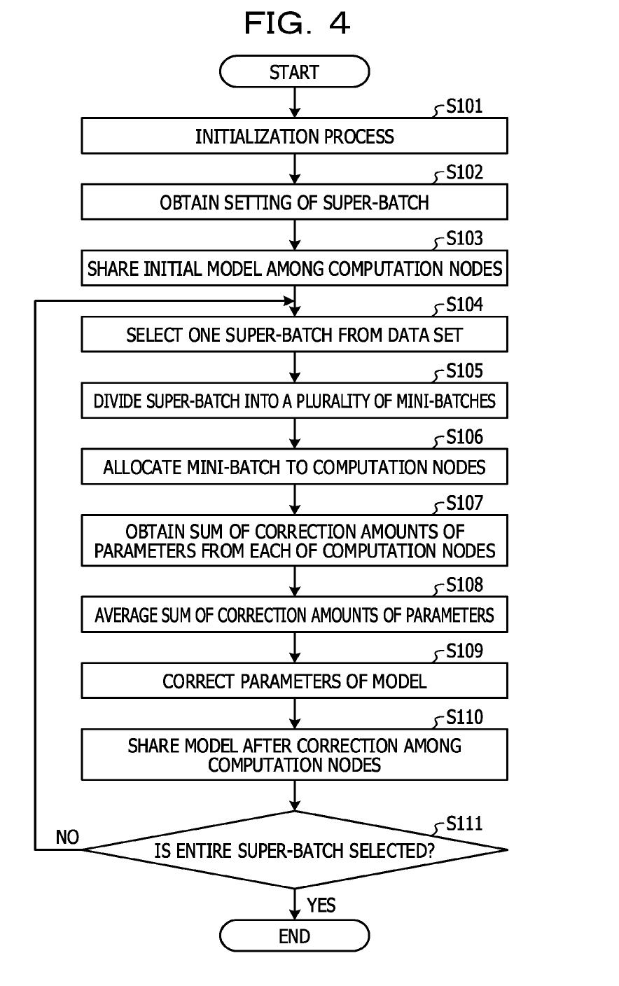

FIG. 4 is a flowchart illustrating a procedure of a machine learning process according to the embodiment 1. As an example, this process is activated in a case where a learning instruction is received from a computer or the like used by a model designer or the like.

As illustrated in FIG. 4, by applying the parameters, for example, the weights and biases to the model designated by the learning instruction among the model data 13b stored in the storage unit 13 and by setting the initial value such as the learning rate, the division unit 15a performs the initialization process (step S101).

Subsequently, the division unit 15a reads setting of the super-batch relating to the data set designated by the learning instruction among the data set 13a stored in the storage unit 13 (step S102). Accordingly, the division unit 15a identifies the computation node 30 participating in the learning from a list designated by the learning instruction, and delivers an initial model to each of the computation nodes 30 (step S103). According to this, the model with the same layered structure and parameters as those of the neural network is shared between the computation nodes 30.

Subsequently, the division unit 15a selects one super-batch among the data set (step S104). The division unit 15a divides the super-batch selected in step S104 into a plurality of mini-batches in accordance with a memory capacity connected to the GPGPU of each of the computation nodes 30 (step S105).

Accordingly, the allocation unit 15b notifies the computation node 30 in charge of the learning of the mini-batch of the identification information of the training sample included in the mini-batch divided from the super-batch in step S105, and thereby allocates the learning of the mini-batch for each of the computation nodes 30 (step S106).

Subsequently, the obtainment unit 15c obtains the sum of the correction amounts of the parameters from each of the computation nodes 30 (step S107). Accordingly, the correction unit 15d averages the sum of the correction amounts of the parameters obtained for each of the computation nodes 30 in step S107 (step S108). Moreover, the correction unit 15d corrects the parameters of the model, that is, the weights and biases, in accordance with the average value averaged by the sum of the correction amounts of the parameters between the computation nodes 30 in step S108 (step S109).

Subsequently, the share unit 15e delivers the model after the correction corrected in step S109 to each of the computation nodes 30 (step S110). According to this, the model after the correction is shared between the computation nodes 30.

Subsequently, until the entire super-batch is selected from the data set (step S111, No), processes of the step S104 to the step S110 are repeatedly performed. Accordingly, in a case where the entire super-batch is selected from the data set (step S111, Yes), the process is ended.

In the flowchart illustrated in FIG. 4, as an example, a case where the learning is ended under a condition that the learning of the super-batch included in the data set makes one round is exemplified. However, the learning of the super-batch can be repeatedly performed over an arbitrary number of loops. For example, the learning may be repeated until a correction value of the parameter becomes equal to or less than a predetermined value, or the number of loops may be limited. In this way, in a case where the learning of the super-batch is looped over a plurality of times, the training samples are shuffled for each loop.

One Aspect of Effect

As described above, the allocation node 10 according to the embodiment distributes the learning relating to the plurality of mini-batches obtained by dividing the super-batch to a plurality of the computation nodes 30A to 30C and processes the distributed learning in parallel. According to this, the size of the super-batch, which is a unit basis for performing the correction of the parameters is restricted by hardware performing data processing relating to the learning; the memory capacity of the computation node 30 in this example. According to the allocation node 10 of the embodiment, it is possible to realize an increase in the size of the batch in which the correction of parameters of the model is performed.

### Embodiment 2

However, although the embodiment relating to the disclosed apparatus is described, the embodiment may be implemented in various different embodiments in addition to the embodiments described above. Therefore, another embodiment included in the embodiment will be described below.

Dropout

In the neural network, there is a case where over learning that an identification rate with respect to a sample other than the training sample decreases occurs while an identification rate with respect to the training sample used for the model learning increases.

In order to suppress the occurrence of the over learning, in the data processing system 1, it is possible to share a seed value and a random number generation algorithm which defines neurons invalidating input or output among neurons included in the model between the computation nodes 30. For example, a uniform random number to be a value of 0 to 1 is generated for each neuron included in each layer of the model, and in a case where the random number value is a predetermined threshold value, for example, equal to or greater than 0.4, the input or output with respect to the neuron is validated, and in a case where it is less than 0.4, the input or output with respect to the neuron is invalidated. In this manner, in a case where dropout is realized, the allocation node 10 shares an algorithm that generates the uniform random number between the computation nodes 30, and also shares the seed value for each neuron used for generation of the uniform random number between the computation nodes 30. Moreover, the allocation node 10 defines a neuron that invalidates input or output of entire neurons according to the uniform random number generated by changing the seed value for each neuron by using the same algorithm between the computation nodes 30. The dropout performed in this manner is continued over a period from the start of learning of the mini-batch divided from the same super-batch at each of the computation nodes 30 to the end thereof.

According to this, as one aspect, the following effect can be obtained. It is possible to increase the batch size without restrictions on the memory capacity and to reduce the over learning. That is, in a system that distributes the learning relating to the plurality of mini-batches divided from the super-batch on the plurality of computation nodes and processes the distributed learning in parallel, it is possible to share the seed value and the random number generation algorithm which defines neurons invalidating input or output among neurons included in the model, and to perform the same learning as learning in which the over learning is suppressed with a unit of the size of the super-batch by correcting the weights and biases based on the sum of the correction amounts of the parameters from the computation node. Accordingly, it is possible to increase the batch size without restrictions on the memory capacity, and to reduce the over learning.

In addition, as another aspect, the following effects can be obtained. For example, in a case where the learning of mini-batch is distributedly performed by each of the computation nodes 30, a situation where communication resources of the data processing system 1 are allocated by notification of the identification information of the training sample included in the mini-batch and notification of the sum of the correction amounts of the parameters, is set. Under the situation, communication for performing the dropout, for example, notification for sharing the neuron that invalidates the input or output on each of the computation nodes 30, or the like may not be performed. Furthermore, since the learning of the super-batch can be realized in a state where the input or output with respect to the same neurons between the computation nodes 30 is invalidated, a result of the model learning is stabilized. That is, even in a case where the distribution process of the model learning relating to the same data set is performed on computation nodes 30 of different number, it is possible to obtain the same learning result. Therefore, it is possible to accurately predict a desirable time or the like from progress of the identification rate of the model, the number of the computation nodes 30, the size of the mini-batch per one computation node 30, or the like to convergence of the model.

Machine Learning Program

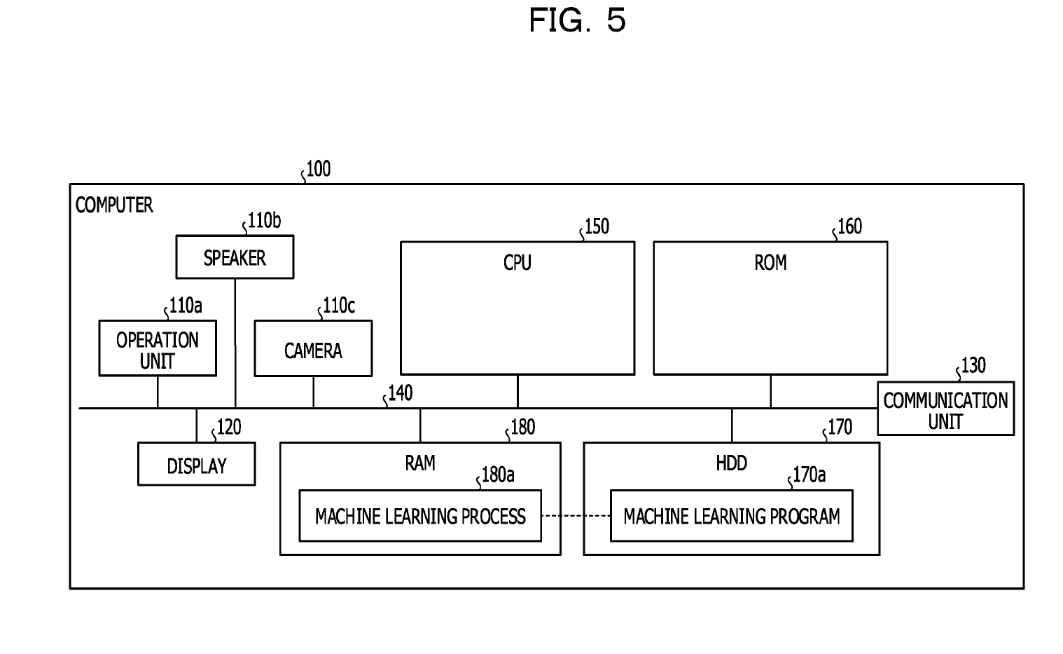

In addition, the various processes described in the above embodiments can be realized by executing a prepared program in advance on a computer such as a personal computer and a workstation. Therefore, in the following, an example of a computer that executes a machine learning program having the same function as the above embodiments will be described with reference to FIG. 5.

FIG. 5 is a diagram illustrating a hardware configuration example of a computer executing the machine learning program according to the embodiment 1 and the embodiment 2. As illustrated in FIG. 5, a computer 100 includes an operation unit 110a, a speaker 110b, a camera 110c, a display 120, and a communication unit 130. Furthermore, the computer 100 includes a CPU 150, ROM 160, a HDD 170, and a RAM 180. These units 110 to 130 and 150 to 180 are connected to each other through a bus 140.

As illustrated in FIG. 5, a machine learning program 170a that exhibits the same function as those of the division unit 15a, the allocation unit 15b, the obtainment unit 15c, the correction unit 15d, and the share unit 15e illustrated in the embodiment 1 is stored in the HDD 170. The machine learning program 170a may be the same as, integrated with, or separated from that in each configuration element of the division unit 15a, the allocation unit 15b, the obtainment unit 15c, the correction unit 15d, and the share unit 15e illustrated in FIG. 2. That is, all data illustrated in the embodiment 1 may be not stored in the HDD 170 at any time, and data used for processing may be stored in the HDD 170.

Under such a circumstance, the CPU 150 reads the machine learning program 170a from the HDD 170 and develops the read machine learning program 170a to the RAM 180. As a result, as illustrated in FIG. 5, the machine learning program 170a functions as a machine learning process 180a. The machine learning process 180a develops various data read from the HDD 170 to a region allocated for the machine learning process 180a among storage regions of the RAM 180, and performs various processes by using the developed various data. For example, a process or the like illustrated in FIG. 4 is included as an example of a process in which the machine learning process 180a is performed. In the CPU 150, all of the processing units described in the embodiment 1 may not be operated at any time, and a processing unit corresponding to a process to be a performance target may be virtually realized.

The machine learning program 170a may not be stored in the HDD 170 or the ROM 160 from the beginning at any time. For example, the machine learning program 170a is stored in a “portable physical medium” such as flexible disks, so-called FDs, CD-ROMs, DVD disks, magneto-optical disks, and IC cards inserted into the computer 100. Accordingly, the computer 100 may perform the machine learning program 170a by obtaining the machine learning program 170a from the portable physical medium. In addition, the machine learning program 170a is stored in another computer, a server device, and the like connected to the computer 100 through a public line, the Internet, a LAN, a WAN, or the like, and thereby the computer 100 may perform the machine learning program 170a by obtaining the machine learning program 170a from these.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A machine learning method using a neural network as a model, the machine learning method being executed by a computer, the machine learning method comprising:
dividing a first batch data into a plurality of pieces of second batch data, the first batch data being a set of sample data to be input into the model in a machine learning, the first batch data having a specified data size in which a parameter of the model is corrected;
allocating the plurality of pieces of second batch data to a plurality of computers, the model having a specified layered structure and a specified parameter of the neural network being applied to the plurality of computers;
making each of the plurality of computers to execute the machine learning based on each of the plurality of allocated second batch data;
obtaining, from each of the plurality of computers, a plurality of correction amounts of the parameter derived by the executed machine learning; and
correcting the model by modifying the specified parameter in accordance with the plurality of correction amounts.

2. The machine learning method according to claim 1, wherein
the process comprises:
applying, to each of the plurality of computers, a seed value and a random number generation algorithm which defines neurons invalidating input or output among neurons included in the model.

3. The machine learning method according to claim 1, wherein
the dividing includes determining a size of each of the plurality of pieces of second batch data in accordance with a memory capacity of each of the plurality of computers.

4. The machine learning method according to claim 1, wherein
the process comprises:
correcting, in the correcting, the model in accordance with an average value of the plurality of correction amounts.

5. The machine learning method according to claim 1, wherein
the process comprises:
applying the corrected model to each of the plurality of computers.

6. A non-transitory computer-readable storage medium storing a program that causes a computer to execute a process, the process comprising:
dividing a first batch data into a plurality of pieces of second batch data, the first batch data being a set of sample data to be input into a model in a machine learning using a neural network as the model, the first batch data having a specified data size in which a parameter of the model is corrected;
allocating the plurality of pieces of second batch data to a plurality of computers, the model having a specified layered structure and a specified parameter of the neural network being applied to the plurality of computers;
making each of the plurality of computers to execute the machine learning based on each of the plurality of allocated second batch data;
obtaining, from each of the plurality of computers, a plurality of correction amounts of the parameter derived by the executed machine learning; and
correcting the model by modifying the specified parameter in accordance with the plurality of correction amounts.

7. An information processing apparatus comprising:
a memory; and
a processor coupled to the memory and the processor configured to:
dividing a first batch data into a plurality of pieces of second batch data, the first batch data being a set of sample data to be input into a model in a machine learning using a neural network as the model, the first batch data having a specified data size in which a parameter of the model is corrected;
allocating the plurality of pieces of second batch data to a plurality of computers, the model having a specified layered structure and a specified parameter of the neural network being applied to the plurality of computers;
making each of the plurality of computers to execute the machine learning based on each of the plurality of allocated second batch data;
obtaining, from each of the plurality of computers, a plurality of correction amounts of the parameter derived by the executed machine learning; and
correcting the model by modifying the specified parameter in accordance with the plurality of correction amounts.
